(19) United States
(12) Patent Application Publication
(10) Pub. No.: US 2026/0213940 A1
(43) Pub. Date: Jul. 23, 2026

(54) Asymmetric Key Generation Process Optimization Using a Multi-Stage Approach

(71) Applicant: DigiCert, Inc., Lehi, UT (US)

(72) Inventors: Atul Gupta, Cupertino, CA (US); Avesta Hojjati, Austin, TX (US)

(73) Assignee: DigiCert, Inc., Lehi, UT (US)

(21) Appl. No.: 19/032,688

(22) Filed: Jan. 21, 2025

(51) Int. Cl. H04L 9/30; H04L 9/08

(52) U.S. Cl. CPC H04L 9/302; H04L 9/0869; H04L 9/3066

(57) ABSTRACT

Systems and methods for generating cryptographic keys in a multi-stage process are provided. A method, in an embodiment, includes generating a plurality of partial cryptographic components adapted for at least one public-key cryptographic algorithm, wherein each partial cryptographic component is generated using a process specific to its respective algorithm; storing the partial cryptographic components in one or more secure pools accessible to a key assembly module; retrieving, by the key assembly module, one or more selected partial cryptographic components from the secure pools based on a requested key type or security parameter; and assembling a public-private key pair from the retrieved partial cryptographic components, wherein assembling the public-private key pair comprises performing reduced cryptographic computations compared to generating all components in a single, monolithic process.

### FIELD OF THE DISCLOSURE

The present disclosure relates generally to computing. More particularly, the present disclosure relates to systems and methods for an asymmetric key generation process optimization using a multi-stage approach.

### BACKGROUND OF THE DISCLOSURE

Cryptographic key pair generation typically begins by creating one or more large prime numbers or high-entropy seeds, which serve as the mathematical foundation for the key. In the case of Rivest-Shamir-Adleman (RSA), two large primes are selected—commonly referred to as p and q—and then multiplied together to form the modulus. The private key is derived from these primes using functions such as the Euler totient (φ) and modular inverse, while the public key is composed of the modulus and a public exponent. In elliptic curve cryptography (ECC), key generation involves choosing a random number as the private key and using this value in an elliptic curve point multiplication to produce the corresponding public key. Across these different algorithms, high-entropy random values are critical to ensure that the resulting keys are secure and resistant to cryptanalysis. When there is a need to generate keys in very large volumes—hundreds of thousands or even millions—the process quickly becomes computationally expensive. Each key pair must undergo an intensive series of prime checks, modular arithmetic operations, or other cryptographic functions.

Because most conventional processes handle seed generation and key assembly on the same machine in a single workflow, a system's hardware can struggle to keep pace with the sheer volume of mathematical computations required. This challenge will intensify with the rise of post-quantum cryptography (PQC), which requires larger key sizes to defend against quantum attacks. As a result, existing methods that rely on monolithic workflows and single-machine computation risk running into performance bottlenecks and scalability issues when confronted with the next generation of cryptographic demands.

### BRIEF SUMMARY OF THE DISCLOSURE

The present disclosure relates to systems and methods for an asymmetric key generation process optimization using a multi-stage approach. The present disclosure includes a prime generation algorithm employing a multi-stage approach that not only identifies valid prime numbers but also continues computations beyond the initial discovery, thereby optimizing both performance and resource usage. In the pre-computation stage, conducted once per batch, the approach handles shared, time-consuming tasks (such as generating initial seeds and checking smaller primes), while a prime generation stage focuses on finalizing individual primes with minimal overhead. By eliminating redundant calculations, the approach achieves a significant reduction in processing power, enabling continuous prime pool maintenance across diverse bit sizes for keys (e.g., 1024, 2048, 3072, and 4096). The benefits include more efficient large-volume prime production, faster throughput for rapid cryptographic key creation, and flexibility in supporting various security requirements-all of which allow organizations to reliably and cost-effectively address both current and future cryptographic demands.

This multi-stage solution for asymmetric key generation optimizes both RSA and ECC workflows by separating computationally expensive tasks into discrete stages and leveraging reusable components. For RSA, the process begins with prime number generation, where a custom algorithm continuously calculates primes—even after finding a valid one—to build large pools at various bit sizes (1024, 2048, 3072, 4096). This approach allows batch-oriented pre-computation of smaller primes and dedicated machines running around the clock, ensuring quick access to ready-to-use primes. The key computation stage then forms moduli by selecting different primes from the pool, offering flexibility (e.g., combining two or four primes) to balance efficiency with security requirements. For instance, a 4096-bit modulus could be constructed from one 1024-bit prime and one 3072-bit prime, or four 1024-bit primes, each strategy optimizing computation and resource utilization. ECC key generation similarly employs seed generation (pre-calculated seed key pairs) followed by key computation using linear combinations of those seeds, dramatically reducing the per-key runtime. By pooling fundamental components—prime numbers in RSA or seed keys in ECC—and minimizing repeated calculations, this system accelerates large-scale key creation, ensures cost-effective resource usage, and provides the flexibility to accommodate future cryptographic demands such as larger key sizes or emerging algorithms.

This multi-stage approach, with separate stages for generating fundamental resources (e.g., seeds or primes) and final key computation, can also be applied to PQC. By identifying and isolating the heavy-lift elements of PQC key generation, organizations could similarly construct dedicated “resource pools” that streamline large-scale or high-volume post-quantum key creation.

### BRIEF DESCRIPTION OF THE DRAWINGS

The present disclosure is detailed through various drawings, where like components or steps are indicated by identical reference numbers for clarity and consistency.

FIG. 1 illustrates a flowchart of a multi-stage process for generating asymmetric cryptographic keys.

FIG. 2 illustrates a block diagram of a computing system, which may be used to perform the multi-stage process of FIG. 1.

### DETAILED DESCRIPTION OF THE DISCLOSURE

Again, the present disclosure relates to systems and methods for an asymmetric key generation process optimization using a multi-stage approach.

### Asymmetric Keys: Definition and Purpose

Asymmetric cryptography, also known as public-key cryptography, relies on two mathematically linked keys: a public key (which can be shared openly) and a private key (which must remain secret). The fundamental concept is that data encrypted with the public key can only be decrypted by the corresponding private key, and vice versa. This separation of keys enables functionalities such as secure communication, authentication, and digital signatures without the need to pre-share a secret key between parties. For example, someone can encrypt a message with your public key, but only your private key can decrypt it, ensuring that only you can read the content.

The present disclosure focuses on optimizing large-scale asymmetric key creation, a critical process for entities such as certificate authorities (CAs) and other organizations that must manage vast numbers of cryptographic keys. In traditional models, generating keys one at a time can cause significant computational bottlenecks, particularly when dealing with short-lived certificates, frequent key rotations, or high-volume provisioning (e.g., Internet-of-things (IoT) deployments or enterprise-grade public key infrastructure solutions). By adopting a multi-stage approach—separating resource-intensive tasks like prime generation or seed creation from the final key assembly—organizations can precompute essential cryptographic components in a dedicated phase. These resources are then held in secure pools at various bit strengths and security levels, ready for on-demand use. Consequently, a CA issuing transport layer security (TLS)/secure sockets layer (SSL) certificates for hundreds of thousands of websites or devices can dramatically reduce processing overhead and turnaround times, accelerating the certificate issuance process while also ensuring robust security controls. Other large-scale environments—such as financial institutions, cloud service providers, or IoT ecosystems—similarly benefit by mitigating performance constraints, simplifying operational workflows, and maintaining high assurance in key material. By minimizing repetitive computations and handling private keys more efficiently, this multi-stage method bolsters both scalability and security, delivering a more flexible and resilient infrastructure for modern cryptographic demands.

### Benefits of Asymmetric Cryptography

Key Distribution: No need to share a secret key in advance; the public key can be shared openly.

Encryption and Decryption: Data can be encrypted by anyone using the public key, but only the private key holder can decrypt it.

Digital Signatures: Allows the creation of verifiable signatures; a private key “signs” a message, and the corresponding public key verifies it.

Scalability: Well-suited for large, distributed environments where secure pre-sharing of symmetric keys is not feasible.

Asymmetric keys form the backbone of modern cryptography, enabling secure communications, authentication, and digital signatures. While RSA relies on the difficulty of factoring large integers, ECC harnesses the discrete logarithm problem on elliptic curves—offering smaller key sizes. PQC schemes, designed to resist quantum-based attacks, employ entirely different hard problems. Each approach has a distinct key generation method tailored to its underlying mathematics, yet all serve a crucial role in ensuring digital security across diverse applications.

### RSA Key Generation

RSA relies on generating two large prime numbers, typically referred to as p and q, each of which must exhibit high entropy so that they are sufficiently unpredictable and resistant to factorization attempts. Once generated, these primes are multiplied to produce the modulus, n (where n=p×q). To facilitate key creation, an auxiliary value known as Euler's totient (φ(n))—or, in some cases, the Carmichael function—is computed; this value indicates how many integers are coprime to n. For the public and private key pair, an exponent e is chosen (commonly 65537) because it offers an optimal balance between security and computational efficiency. The private exponent d is then derived by calculating the modular inverse of e modulo φ(n). As a result, the public key is the pair (e, n), whereas the private key is (d, n).

In practice, RSA key sizes can range from 1024 bits (largely considered insufficient by modern standards) to 4096 bits or more, depending on security requirements and performance considerations. Many software libraries implement further optimizations, such as the Chinese Remainder Theorem (CRT), which accelerates private-key operations by separately computing exponentiations modulo p and q. Because RSA encryption and signatures depend on the hardness of factoring these large moduli, its cryptographic strength increases with the size of p and q. Consequently, RSA is widely used for secure data transmission, key exchange protocols (e.g., TLS/SSL), and digital signatures (e.g., signing software or documents). Its broad adoption in Public Key Infrastructure (PKI) systems underlines its importance in internet security and enterprise environments.

### ECC Key Generation

ECC operates on an elliptic curve defined over a finite field, typically described by the equation

$${y}^{2} = {x}^{3} + a x + b ( mod p )$$

Industry-standard curves—such as secp256r1 (also known as P-256), secp384r1 (P-384), and secp521 r1 (P-521)—specify parameters including the prime p, curve coefficients a and b, a base point G, and the curve's order (the total number of valid points on the curve). A private key in ECC is a randomly chosen integer k less than the order of the curve, providing sufficient entropy for security. The corresponding public key is obtained through scalar multiplication of the base point, kG. While the forward operation (k→kG) is computationally efficient, the reverse process (kG→k) is prohibitively difficult due to the elliptic curve discrete logarithm problem.

Because ECC achieves security comparable to RSA at much smaller key sizes (for instance, a 256-bit ECC key roughly corresponds to the strength of a 3072-bit RSA key), it is particularly suitable for constrained environments, such as IoT devices and mobile applications. ECC supports various cryptographic functions, including digital signatures (e.g., ECDSA) and key exchange protocols (e.g., ECDH). These protocols are widely used to secure data in transit—for example, in TLS/SSL connections. In addition, ephemeral versions of these algorithms (ECDHE) provide forward secrecy, ensuring that even if a private key is compromised in the future, previously established session keys remain secure. This blend of efficiency and robust security has made ECC a cornerstone of modern cryptographic solutions, from protecting web traffic to securing blockchain transactions.

### PQC Key Generation

PQC is designed to be secure against attacks by quantum computers. Algorithms typically rely on different hard mathematical problems (e.g., lattice-based problems) rather than integer factorization or discrete logarithms. There are various PQC schemes, including lattice-based (e.g., CRYSTALS-Kyber, CRYSTALS-Dilithium), code-based (e.g., McEliece), hash-based, and more. Each has its own unique method of generating public and private keys. Depending on the algorithm, certain parameters (e.g., dimension of the lattice, error distribution) are chosen for the required security level. A random “secret” structure (e.g., a polynomial, a matrix, or a vector) is generated. The public key is derived by applying a specific transformation—often adding “noise” or multiplying by a random matrix—so that reversing the transformation without the private information is computationally infeasible, even for a quantum computer. PQC algorithms aim to replace or augment classical algorithms like RSA and ECC to ensure long-term security in the face of advancing quantum technology. Transition plans often involve hybrid solutions, combining classical and post-quantum keys.

### Prime Numbers

Prime numbers are fundamental to RSA, ECC, and various PQC schemes—because they form the mathematical bedrock that ensures cryptographic hardness. Although each algorithm exploits prime numbers differently, the overarching reason is that primes confer desirable properties in modular arithmetic and group theory, making it computationally infeasible to reverse-engineer the private key from the public information.

RSA constructs its modulus n by multiplying two (or more) large primes, often denoted p and q. The security of RSA hinges on the fact that factoring n back into p and q is extremely difficult. Once n is formed, crucial steps like calculating the Euler's totient (or the Carmichael function) rely on p and q being prime to derive the private exponent. This entire structure breaks down if p or q is easily factorable or not truly prime.

In many ECC implementations (e.g., secp256r1), calculations occur over a prime finite field. These prime fields avoid the complication of having nontrivial common divisors; in other words, arithmetic “wraps around” in a predictable, well-defined way. The difficulty of solving the elliptic curve discrete logarithm problem (ECDLP) depends on the structure of the group formed over a prime field. A properly chosen prime p of sufficient size ensures a large group order and renders it computationally infeasible to derive the private key k from the public key kG.

While not all post-quantum algorithms require primes, many rely on prime moduli or other prime-based assumptions to build lattice, code-based, or isogeny-based cryptographic schemes. For instance, certain isogeny-based protocols (like SIKE) work over supersingular elliptic curves defined by prime fields, and some lattice-based schemes (e.g., NTRU variants) use polynomial rings modulo a prime. Similar to RSA and ECC, PQC schemes rely on “hard” mathematical problems. Primes are often leveraged because they maintain well-structured, high-entropy spaces that remain resistant to both classical and quantum attack algorithms.

In all three cases—RSA, ECC, and many PQC algorithms—prime numbers are crucial for establishing an arithmetic environment that is difficult to invert and thus underpins cryptographic security. Large primes, carefully generated and validated, ensure that attackers cannot feasibly solve the underlying mathematical problems (factoring, discrete logarithms, or post-quantum equivalents) with current or near-future computational power.

### Optimizing Large-Scale Prime Generation and Key Creation Using a Multi-Stage Approach

Again, modern cryptographic systems often require generating large numbers of asymmetric key pairs—whether based on RSA, ECC, or emerging post-quantum cryptography (PQC). This process can quickly become computationally expensive, especially as key sizes grow and organizations need to produce large volumes of keys rapidly. Traditional one-step workflows, which combine seed or prime generation with final key assembly, become increasingly resource-intensive when millions of keys are involved or when cryptographic requirements demand frequent rotations. The multi-stage approach described here addresses these challenges by separating prime or seed generation (Stage 1) from final key assembly (Stage 2), minimizing redundant computations and enabling dedicated, high-performance resources to perform the most demanding tasks.

At the outset, a cluster of powerful machines focuses exclusively on prime (or seed) generation, continuously replenishing secure “pools” of cryptographic building blocks. In RSA environments, the system may produce prime numbers of various bit lengths—such as 1024, 2048, 3072, or 4096—and store them so that they can be combined efficiently later. For ECC, dedicated servers pre-generate seed key pairs, each of which only needs a few additional steps to finalize. A custom prime generation algorithm underpins much of the efficiency: rather than stopping when a single prime is found, it continues searching through additional candidates, thus amortizing the cost of partial primality checks and small-prime filtering over multiple prime outputs. This algorithm operates in a pre-computation phase (once per batch) for tasks like preliminary seed generation and smaller prime checks, followed by a prime-refinement phase (once per prime), which polishes individual candidates to cryptographic standards.

Once the secure pools of primes or seeds are ready, relatively modest machines can assemble final keys on demand. In the RSA context, choosing two primes (or more for multi-prime RSA) allows quick calculation of the modulus n=p×q, public exponent e, and private exponent d, all of which rely on arithmetic that is no longer constrained by on-the-fly prime generation. The use of different prime bit sizes lets organizations balance performance and security requirements; for instance, a 4096-bit RSA key can be formed from two 2048-bit primes or one 1024-bit prime plus one 3072-bit prime. ECC benefits similarly by combining several pre-generated seed keys; the final private key k might be a linear combination of a small number of seed values, and the corresponding public key kG can be computed with a handful of point additions and scalar multiplications. This not only saves computational effort but also maintains strong security postures, since the heavy-lifting math—whether it involves prime checks or elliptic curve preparations—was already handled in the first stage.

Extending this idea to PQC follows the same principle. Although PQC algorithms often rely on more complex structures like large random matrices, polynomials over high-degree rings, or isogenies on elliptic curves, the core concept remains: identify and precompute the costliest steps in a secure, high-performance environment, then store partial artifacts that can be assembled into final keys with minimal effort. Whether the scheme is lattice-based, code-based, or isogeny-based, partial data such as polynomials or partial isogeny paths can be maintained in a secure pool and finalized only when a new key request arises, thus spreading out the intense computations and reducing real-time demands on the system.

This multi-stage design provides several key benefits. First, performance and scalability are improved by avoiding repeated heavy tasks—millions of keys can be generated without grinding each individual operation from scratch. Second, security is enhanced because only partial information (primes, seeds, or partial PQC structures) is stored rather than full private keys; if the pool is compromised, it is less damaging than losing a full set of final keys. Third, resource optimization becomes possible: high-end hardware for prime or seed generation can be consolidated in specialized clusters, while simpler devices handle final key assembly. Finally, the approach is future-ready. It easily adapts to new security standards, higher key lengths, or PQC algorithms without forcing a complete overhaul of the system; one need only update or augment the precomputation steps to cover new parameters or mathematical constructs.

Organizations likely to benefit the most include Certificate Authorities (CAs) issuing short-lived certificates for millions of clients, financial institutions performing large-scale key rotations, and IoT vendors provisioning massive device fleets. In these settings, real-time generation of each new key can cause significant delays or hardware spikes if performed one by one. By contrast, an assembly line approach ensures that prime pools (or PQC pools) remain continuously refreshed and that final key creation becomes a quick, predictable procedure. Even advanced RSA setups involving multi-prime moduli, or ECC setups with large comb tables, see improvements in throughput. The same logic underpins the transition to hybrid or fully post-quantum cryptographic systems, where partial structures such as large matrices or isogenies can be precomputed and stored securely for on-demand finalization.

In summary, this two-stage methodology—where specialized, high-performance systems continuously generate cryptographic materials while separate, less demanding machines assemble final keys—streamlines large-scale key creation for both classical and next-generation algorithms. By decoupling prime or seed generation from final key assembly, organizations can maintain efficient, secure, and scalable cryptographic infrastructures even under intensive workloads. This approach not only addresses present needs for robust RSA and ECC deployments but also stands poised to accommodate the complexity and volume requirements of PQC, ensuring that modern cryptography evolves smoothly into the post-quantum era.

### Generating Cryptographic Keys in a Multi-Stage Process

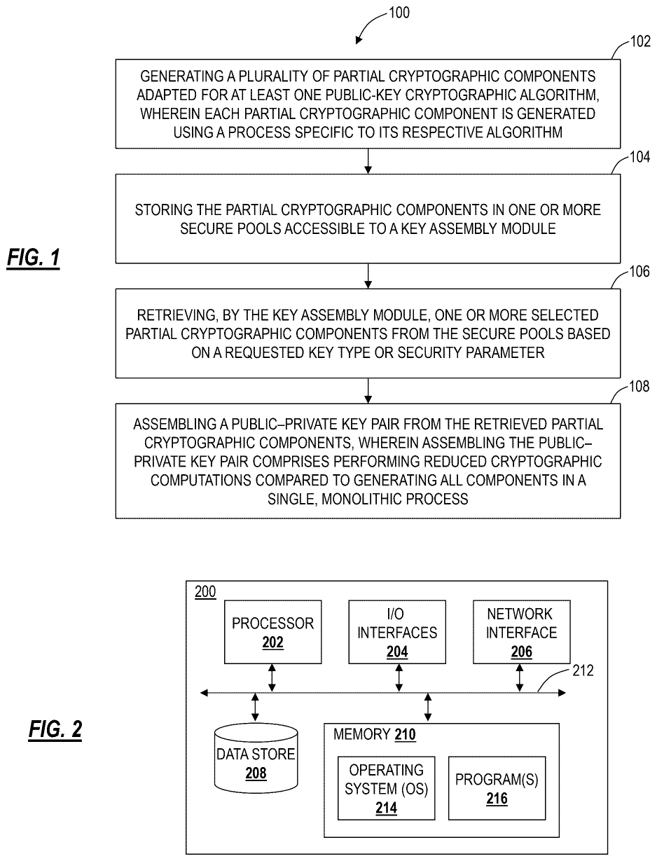

FIG. 1 illustrates a flowchart of a multi-stage process 100 for generating asymmetric cryptographic keys. The process 100 can be implemented in various ways, including: as a method including steps, via circuitry (specialized hardware and/or general-purpose hardware configured to execute those steps), and through a non-transitory computer-readable medium that stores instructions which, when executed, cause one or more processors to perform the steps. This flexibility ensures the process 100 can be adapted to different system architectures and deployment scenarios.

The steps include generating a plurality of partial cryptographic components adapted for at least one public-key cryptographic algorithm, wherein each partial cryptographic component is generated using a process specific to its respective algorithm (step 102); storing the partial cryptographic components in one or more secure pools accessible to a key assembly module (step 104); retrieving, by the key assembly module, one or more selected partial cryptographic components from the secure pools based on a requested key type or security parameter (step 106); and assembling a public-private key pair from the retrieved partial cryptographic components, wherein assembling the public-private key pair comprises performing reduced cryptographic computations compared to generating all components in a single, monolithic process (step 108). The at least one public-key cryptographic algorithm can include one of RSA, elliptic curve cryptography (ECC), or post-quantum cryptography (PQC).

Generating the partial cryptographic components can be performed on specialized hardware including any of multi-core or hardware-accelerated processors configured to perform large-integer arithmetic or polynomial operations in parallel; at least one dedicated hardware-based random number generator (RNG) for supplying high-entropy seed values; or secure storage modules or hardware security modules (HSMs) configured to store intermediate generation data in an encrypted manner, and wherein the specialized hardware operates continuously or at scheduled intervals to replenish the secure pools with newly generated partial cryptographic components.

Assembling the public-private key pair can be performed on general-purpose hardware that: retrieves the partial cryptographic components from the secure pools over a network or local bus; performs final modular arithmetic, scalar multiplications, or other finite-field operations using a general-purpose processor; and implements standard cryptographic libraries to finalize the key pair without requiring specialized hardware used in the generating.

In an embodiment, the partial cryptographic components for RSA include large prime numbers generated by: continuously testing candidate integers for primality even after identifying at least one valid prime; performing batch-oriented sieving or partial primality tests once per group of candidate integers; and storing validated primes of a given bit length. Assembling the public-private key pair for RSA specifically includes: selecting two or more prime numbers from the secure pools; computing a modulus n from the primes; choosing or applying a public exponent e; and deriving a private exponent d by calculating a modular inverse of e relative to φ(n) or a variant thereof, wherein the total arithmetic operations required for final key assembly are substantially reduced compared to a single-step generation process. The steps can include forming an RSA modulus n from more than two primes of potentially varying bit lengths, such that at least one prime is smaller than another prime, thereby balancing performance and security requirements through selective combination of partial cryptographic components.

In another embodiment, the partial cryptographic components are for ECC and include seed key pairs {(kᵢ, Gᵢ)}, each defined over an elliptic curve, the steps further include generating each seed key pair such that Gᵢ=kᵢ×G, where G is a base point on the elliptic curve; and validating that each kᵢ provides sufficient randomness and lies within an order suitable for the elliptic curve, such that a final private key of a newly requested ECC key pair is assembled by combining a subset of the seed key pairs via scalar multiplication and point addition. Assembling the final ECC key pair (k, kG) further includes: receiving one or more coefficients {a₀, a₁, . . . , a_{N}} for combining a subset of seed key pairs; forming the private key k=Σaᵢ·kᵢ; and deriving the public key kG=Σaᵢ·Gᵢ, wherein the final assembly module on general-purpose hardware needs only a limited number of point additions and scalar multiplications to produce the completed key.

In a further embodiment, the partial cryptographic component are for PQC and include at least one of: partially formed polynomials or matrices for lattice-based schemes, generated by expanding high-entropy seeds and filtering out invalid or weak structures; code-based error-correcting parameters prepared in advance to simplify final key construction; or precomputed isogeny paths or auxiliary curves for isogeny-based cryptography, such that completing a post-quantum public-private key pair requires only a lightweight combination or transformation of these stored partial structures. Assembling the final post-quantum public-private key pair includes: selecting at least one partially computed structure from the secure pools; adding ephemeral randomness or applying short transformations to finalize the private key; and performing the remaining polynomial multiplication, matrix operation, or isogeny step(s) to generate the public key, thereby minimizing the on-demand computational effort for PQC key creation.

The steps can further include marking or removing each partial cryptographic component from the secure pools upon usage for final key assembly, thereby preventing reuse of a same partial cryptographic component in multiple key pairs and mitigating risks associated with repeated prime factors or repeated parameters. Generating the partial cryptographic components can be performed continuously or at scheduled intervals, and the steps further include monitoring a quantity of available partial cryptographic components in each pool; triggering additional generation cycles when at least one pool falls below a predefined threshold; and maintaining a state of readiness by ensuring that secure pools always hold sufficient partial cryptographic components for anticipated demand.

The multi-stage process can be implemented by a Certificate Authority (CA) issuing digital certificates, such that specialized hardware continuously performing the generating, storing in secure pools of multiple bit sizes; a CA's issuance service on general-purpose servers retrieves these components to finalize public-private key pairs for end-entity certificates; and large-scale or frequent key creation is accelerated by offloading computationally expensive steps to the specialized hardware.

### Example Computing Device Architecture, Cloud Deployment, and Use in the Multi-Stage Approach

FIG. 2 illustrates a block diagram of a computing system 200, which may be used to perform the multi-stage cryptographic approach described herein. The computing system 200 can be implemented in many ways, including physical servers, clusters of machines, virtual machines (VMs) running on hypervisors, or serverless computing frameworks. Regardless of the underlying infrastructure, the computing system 200 typically includes one or more processors 202, input/output (I/O) interfaces 204, a network interface 206, a data store 208, and memory 210.

It should be noted that FIG. 2 presents a simplified view; in practice, the computing system 200 may feature additional hardware and software components such as accelerators, GPUs, FPGAs, dedicated cryptographic modules, and more sophisticated interconnect fabrics. These components 202, 204, 206, 208, and 210 are coupled via a local interface 212, which may include various wired or wireless buses, high-speed interconnects, or switching fabrics. The local interface 212 can also include controllers, buffers, caches, drivers, repeaters, and receivers, along with addressing and control lines to promote efficient communication and resource sharing among components.

Each processor 202 is a hardware element—such as a CPU, multicore processor, system-on-chip (SoC), GPU, or a processing element in a larger compute cluster—designed to execute software instructions. These processors may be general-purpose or specialized, selected based on performance, power efficiency, or workload needs. During operation, each processor 202 retrieves and executes instructions stored in memory 210, coordinates data exchanges with the data store 208, and manages overall system activities. In large-scale environments, multiple processors 202 can be used in parallel computing architectures to handle elevated traffic and complex workloads efficiently.

The I/O interfaces 204 allow the computing system 200 to interact with external peripherals, enabling both user input (e.g., via keyboards, touchscreens, or sensors) and system output (e.g., to displays or printers). Depending on the application, these I/O interfaces 204 can also support specialized devices for maintenance, debugging, or other administrative functions. Meanwhile, the network interface 206 handles connectivity to external networks, which may include the Internet, private corporate networks, or cloud environments. This network interface can be based on Ethernet, Wireless LAN, 5G, or a virtualized cloud interface. By relying on secure transport protocols and encryption, data transmitted via the network interface 206 can remain protected, enabling the computing system 200 to participate in distributed or cloud-based deployments.

The data store 208 provides storage for both persistent and temporary data. This storage may utilize volatile memory (e.g., RAM) for transient, high-speed operations or nonvolatile media (e.g., solid-state drives, hard disk drives, optical media) for durable, long-term retention. In some deployments, the data store 208 may be integrated with network-attached storage (NAS), storage area networks (SAN), or cloud-based storage solutions.

These configurations can scale from modest local setups to enterprise-level installations, potentially offering features such as global deduplication, compression, encryption at rest, and multi-site replication. The data store 208 may hold operational logs, configuration details, policy rules, program binaries, and cached computation results.

The memory 210 is the primary working memory for the processors 202, often composed of volatile elements like DRAM (e.g., DDR, SDRAM) for speed, though it may also include nonvolatile components such as Flash memory or NVRAM. Memory 210 can be distributed across nodes or servers, supporting large-scale in-memory processing demanded by modern cloud services. Typically, the memory 210 stores the operating system (O/S) 214 and one or more programs 216. The O/S 214 handles core system tasks such as process scheduling, memory allocation, file management, and networking. Above this operating system layer, the programs 216 implement the multi-stage asymmetric key generation approach or any other specialized features required by the computing system 200.

The computing system 200 can be deployed as a private cloud in a single organization's datacenter, a public cloud hosted by a third-party provider, or a hybrid cloud combining elements of both for specific security, performance, or compliance considerations. Cloud computing abstracts physical hardware—servers, storage devices, network components—into on-demand, scalable resources. This enables organizations to provision computing power, storage, and network bandwidth with minimal upfront expenses, adapting to fluctuating workload demands.

According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing the hosting of applications allows providers to uniformly release new features, apply security patches, and manage licensing. These cloud-based models, often referred to as “Software as a Service” (SaaS), allow end users to access the software through browsers or lightweight client applications, benefiting from continuous improvements and frequent updates.

In a multi-stage cryptographic system, the computing system 200 can include specialized hardware for prime number generation—such as high-performance servers or devices focused on CPU-intensive and entropy-related tasks. By contrast, a key assembly module may run on general-purpose hardware (which can also be based on the computing system 200) to assemble final public-private key pairs from these precomputed primes, resulting in minimal additional computational burden.

### Specialized Hardware for Prime Number Generation

Specialized hardware for prime number generation can feature high-performance CPUs or accelerators with many cores (e.g., dozens or hundreds) to run large-scale primality tests in parallel. GPUs or FPGAs may also accelerate modular exponentiations, sieving algorithms, or large-integer arithmetic. Dedicated randomness sources, such as true hardware random number generators (RNGs) or specialized circuits that harvest environmental noise (e.g., thermal or electromagnetic), ensure robust entropy. High-speed arithmetic units—like extended precision ALUs—can handle large-integer operations (1024-bit, 2048-bit, etc.) significantly faster, while vectorized instructions (SIMD) facilitate bulk operations or small-prime filtering. A parallel pipeline architecture allows batch processing of candidate creation, sieving, partial primality checks (e.g., Miller-Rabin), and result validation, which can be balanced via a load balancer distributing tasks across available CPU or accelerator resources. Secure storage options, including hardware security modules (HSMs) or encrypted databases, guard validated primes at multiple bit lengths. This specialized hardware often operates continuously to maintain fresh pools of cryptographically secure primes, supported by robust cooling and redundancy to handle extensive workloads.

### Running the Key Assembly Module on General-Purpose Hardware

While prime generation demands substantial computation and entropy, assembling final keys from precomputed primes is comparatively lightweight. Once two or more primes are retrieved from the pool, forming the RSA modulus n=p×q and calculating exponents e and d, or for ECC, combining seed key pairs through point addition and scalar multiplication, consumes only a fraction of the cycles needed for prime generation. General-purpose machines running C, C++, Java, Python, or similar languages can use standard cryptographic libraries to handle modular exponentiations, inverses, or elliptic curve operations. Because these tasks are less mathematically demanding than prime discovery, the key assembly module can be deployed on standard application servers, cloud instances, or even embedded IoT devices. This process can easily scale via load balancing across multiple servers. If the system detects the prime pool running low, it can prompt the specialized hardware to replenish resources. From a security standpoint, the private key assembly benefits from secure coding, role-based controls, and ephemeral in-memory use of key material. Higher-assurance requirements can still be met with local HSMs managing the final exponent or elliptic curve multiplications, balancing flexibility and security.

In essence, this approach separates the heavy-lifting tasks—continuous prime or seed generation—from the relatively simpler assembly phase. By hosting prime generation on specialized hardware optimized for parallel arithmetic and entropy gathering, and allowing any general-purpose machine to finalize cryptographic keys, organizations gain a scalable, cost-effective, and adaptable environment for modern cryptographic applications.

### Processing Circuitry and Non-Transitory Computer-Readable Media

Various embodiments may rely on different forms of processing circuitry—general-purpose microprocessors, CPUs, DSPs, network processors, GPUs, FPGAs, PLDs, or similar. This circuitry may be controlled by software, firmware, or a combination thereof, possibly in combination with non-processor circuits, to accomplish the functionalities outlined here. Alternatively, specific tasks may be implemented by state machines or one or more ASICs (application-specific integrated circuits), each addressing certain functions through dedicated logic. In some cases, a hybrid approach that merges these strategies may be adopted. Moreover, implementations can include a non-transitory computer-readable storage medium that holds computer-readable instructions. When executed by a device containing suitable processing circuitry, these instructions drive the system to perform the disclosed methods or algorithms, from prime generation and management to key assembly. Examples of non-transitory storage media include hard disks, optical disks, magnetic devices, ROM, PROM, EPROM, EEPROM, flash memory, or other forms of persistent/semi-persistent storage. Once stored, the executable instructions enable the system to fulfill the methods detailed in this disclosure, supporting the multi-stage cryptographic strategy across a wide variety of use cases.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for generating cryptographic keys in a multi-stage process, the method comprising:
generating a plurality of partial cryptographic components adapted for at least one public-key cryptographic algorithm, wherein each partial cryptographic component is generated using a process specific to its respective algorithm;
storing the partial cryptographic components in one or more secure pools accessible to a key assembly module;
retrieving, by the key assembly module, one or more selected partial cryptographic components from the secure pools based on a requested key type or security parameter; and
assembling a public-private key pair from the retrieved partial cryptographic components, wherein assembling the public-private key pair comprises performing reduced cryptographic computations compared to generating all components in a single, monolithic process.

2. The method of claim 1, wherein the at least one public-key cryptographic algorithm includes one of RSA, elliptic curve cryptography (ECC), or post-quantum cryptography (PQC).

3. The method of claim 1, wherein generating the partial cryptographic components is performed on specialized hardware including any of
multi-core or hardware-accelerated processors configured to perform large-integer arithmetic or polynomial operations in parallel;
at least one dedicated hardware-based random number generator (RNG) for supplying high-entropy seed values; or
secure storage modules or hardware security modules (HSMs) configured to store intermediate generation data in an encrypted manner, and
wherein the specialized hardware operates continuously or at scheduled intervals to replenish the secure pools with newly generated partial cryptographic components.

4. The method of claim 1, wherein assembling the public-private key pair is performed on general-purpose hardware that:
retrieves the partial cryptographic components from the secure pools over a network or local bus;
performs final modular arithmetic, scalar multiplications, or other finite-field operations using a general-purpose processor; and
implements standard cryptographic libraries to finalize the key pair without requiring specialized hardware used in the generating.

5. The method of claim 1, wherein the partial cryptographic components for RSA include large prime numbers generated by:
continuously testing candidate integers for primality even after identifying at least one valid prime;
performing batch-oriented sieving or partial primality tests once per group of candidate integers; and
storing validated primes of a given bit length.

6. The method of claim 1, wherein the partial cryptographic components for ECC include seed key pairs {(kᵢ, Gᵢ)}, each defined over an elliptic curve, the method further comprising:
generating each seed key pair such that Gᵢ=kᵢ×G, where G is a base point on the elliptic curve; and
validating that each kᵢ provides sufficient randomness and lies within an order suitable for the elliptic curve, such that a final private key of a newly requested ECC key pair is assembled by combining a subset of the seed key pairs via scalar multiplication and point addition.

7. The method of claim 1, wherein the partial cryptographic components for PQC include at least one of:
partially formed polynomials or matrices for lattice-based schemes, generated by expanding high-entropy seeds and filtering out invalid or weak structures;
code-based error-correcting parameters prepared in advance to simplify final key construction; or
precomputed isogeny paths or auxiliary curves for isogeny-based cryptography,
such that completing a post-quantum public-private key pair requires only a lightweight combination or transformation of these stored partial structures.

8. The method of claim 1, further comprising:
marking or removing each partial cryptographic component from the secure pools upon usage for final key assembly, thereby preventing reuse of a same partial cryptographic component in multiple key pairs and mitigating risks associated with repeated prime factors or repeated parameters.

9. The method of claim 1, wherein generating the partial cryptographic components is performed continuously or at scheduled intervals, and the method further comprising:
monitoring a quantity of available partial cryptographic components in each pool;
triggering additional generation cycles when at least one pool falls below a predefined threshold; and
maintaining a state of readiness by ensuring that secure pools always hold sufficient partial cryptographic components for anticipated demand.

10. The method of claim 1, wherein the multi-stage process is implemented by a Certificate Authority (CA) issuing digital certificates, such that
specialized hardware continuously performing the generating, storing in secure pools of multiple bit sizes;
a CA's issuance service on general-purpose servers retrieves these components to finalize public-private key pairs for end-entity certificates; and
large-scale or frequent key creation is accelerated by offloading computationally expensive steps to the specialized hardware.

11. A system for generating cryptographic keys in a multi-stage process, the system comprising:
specialized hardware configured to:
generate a plurality of partial cryptographic components adapted for at least one public-key cryptographic algorithm, wherein each partial cryptographic component is generated using a process specific to its respective algorithm; and
store the partial cryptographic components in one or more secure pools accessible to a key assembly module; and
general-purpose hardware configured to:
retrieve, by the key assembly module, one or more selected partial cryptographic components from the secure pools based on a requested key type or security parameter; and
assemble a public-private key pair from the retrieved partial cryptographic components, wherein assembling the public-private key pair comprises performing reduced cryptographic computations compared to generating all components in a single, monolithic process.

12. The system of claim 11, wherein the at least one public-key cryptographic algorithm includes one of RSA, elliptic curve cryptography (ECC), or post-quantum cryptography (PQC).

13. The system of claim 11, wherein the specialized hardware includes any of
multi-core or hardware-accelerated processors configured to perform large-integer arithmetic or polynomial operations in parallel;
at least one dedicated hardware-based random number generator (RNG) for supplying high-entropy seed values; or
secure storage modules or hardware security modules (HSMs) configured to store intermediate generation data in an encrypted manner, and
wherein the specialized hardware operates continuously or at scheduled intervals to replenish the secure pools with newly generated partial cryptographic components.

14. The system of claim 11, wherein the general-purpose hardware:
retrieves the partial cryptographic components from the secure pools over a network or local bus;
performs final modular arithmetic, scalar multiplications, or other finite-field operations using a general-purpose processor; and
implements standard cryptographic libraries to finalize the key pair without requiring specialized hardware used in the generating.

15. The system of claim 11, wherein the general-purpose hardware or the specialized hardware are configured to:
mark or remove each partial cryptographic component from the secure pools upon usage for final key assembly, thereby preventing reuse of a same partial cryptographic component in multiple key pairs and mitigating risks associated with repeated prime factors or repeated parameters.

16. A non-transitory computer-readable medium storing instructions for generating cryptographic keys in a multi-stage process, the instructions, when executed, cause one or more processors to perform steps of:
generating a plurality of partial cryptographic components adapted for at least one public-key cryptographic algorithm, wherein each partial cryptographic component is generated using a process specific to its respective algorithm;
storing the partial cryptographic components in one or more secure pools accessible to a key assembly module;
retrieving, by the key assembly module, one or more selected partial cryptographic components from the secure pools based on a requested key type or security parameter; and
assembling a public-private key pair from the retrieved partial cryptographic components, wherein assembling the public-private key pair comprises performing reduced cryptographic computations compared to generating all components in a single, monolithic process.

17. The non-transitory computer-readable medium of claim 16, wherein the at least one public-key cryptographic algorithm includes one of RSA, elliptic curve cryptography (ECC), or post-quantum cryptography (PQC).

18. The non-transitory computer-readable medium of claim 16, wherein generating the partial cryptographic components is performed on specialized hardware including any of
multi-core or hardware-accelerated processors configured to perform large-integer arithmetic or polynomial operations in parallel;
at least one dedicated hardware-based random number generator (RNG) for supplying high-entropy seed values; or
secure storage modules or hardware security modules (HSMs) configured to store intermediate generation data in an encrypted manner, and
wherein the specialized hardware operates continuously or at scheduled intervals to replenish the secure pools with newly generated partial cryptographic components.

19. The non-transitory computer-readable medium of claim 16, wherein assembling the public-private key pair is performed on general-purpose hardware that:
retrieves the partial cryptographic components from the secure pools over a network or local bus;
performs final modular arithmetic, scalar multiplications, or other finite-field operations using a general-purpose processor; and
implements standard cryptographic libraries to finalize the key pair without requiring specialized hardware used in the generating.

20. The non-transitory computer-readable medium of claim 16, wherein the steps further include:
marking or removing each partial cryptographic component from the secure pools upon usage for final key assembly, thereby preventing reuse of a same partial cryptographic component in multiple key pairs and mitigating risks associated with repeated prime factors or repeated parameters.
